(19) United States
(12) Patent Application Publication
(10) Pub. No.: US 2015/0231838 A1
(43) Pub. Date: Aug. 20, 2015

(54) LOW VISCOSITY TIRE SEALANT

(71) Applicants: Brandon Ragan, Srpingfield, VA (US); Philip Ragan, SR., Horseheads, NY (US)

(72) Inventors: Brandon Ragan, Srpingfield, VA (US); Philip Ragan, SR., Horseheads, NY (US)

(21) Appl. No.: 14/607,398

(22) Filed: Jan. 28, 2015

Related U.S. Application Data
(60) Provisional application No. 61/932,382, filed on Jan. 28, 2014.

(51) Int. Cl. B29C 73/16

(52) U.S. Cl. CPC B29C 73/163

(57) ABSTRACT

The invention relates to the in tandem use of specific ingredients for a tire sealant formulation that will repair and/or prevent future flats caused by any type of air loss in a pneumatic tire. It is desirable for a tire sealant formula to contain various sized and shaped particles/objects to form a clot that will plug any punctures and/or leaks in the tire. Another desirable feature of a tire sealant is to provide a seal that is permanent and will last the life of the tire where in prior art formulations it is common for non-adhesive based tire sealants to leak and not provide a permanent fix for the leak and/or puncture. It is also desirable for the liquid to be lightweight and low viscosity for a faster flowing liquid with low flowing resistance which is not common in prior art tire sealants. The aforementioned characteristics are key to creating a tire sealant formulation that requires less sealant to be applied inside the tire. It is favorable to use less quantity of tire sealant in some tires because larger quantities of tire sealant will cause tire balance issues and the application of less tire sealant into a tire is quicker and easier. The present invention solves the aforementioned problems by creating a low viscosity, lightweight liquid that contains the right type and amount of particles/objects as well as the right adhesive to provide the plug needed to form a permanent plug/clot and seal any punctures/holes and/or leaks while using up to 75% less tire sealant in comparison to many prior art formulations.

This application is a divisional/continuation-in part/etc. of application Ser. No. ______, filed, entitled, which is incorporated herein by reference.

### FIELD OF THE INVENTION

The invention relates to a low viscosity liquid containing at least pulp and/or floc fiber (further defined later in this patent) and liquid latex (further defined later in this patent) for the purpose of fixing or repairing or sealing 1 or more leak(s) and/or puncture(s) in the tire tread and/or tire sidewalls and/or tire bead (the seal created between the rim and tire).

### BACKGROUND OF THE INVENTION

The present invention solves many problems faced when formulating a tire sealant for the purpose of tire repair or flat prevention caused by punctures and/or leaks. Applications include any pneumatic tire on vehicles, equipment or tools. The invention grew out of the need to provide a tire repair sealant and/or flat prevention tire sealant that would permanently seal and last for the life of the tire as well as create less mess during application and/or removal of the tire sealant from the tire. The invention also grew from the need for a tire sealant that requires less tire sealant to be applied into a tire for the purpose of repairing and/or preventing a flat tire caused by punctures and/or leaks. The aforementioned preferred characteristics are all offered by the present invention.

### DEFINITIONS AND DECLARATIONS

The following definitions and declarations are to be known throughout this patent:

The use of the terms “floc fiber” or “pulp fiber” shall be defined and known as the following below description through the entirety of this patent. The present invention proposes the use of natural and/or synthetic pulp fiber fibrillated to <3 mm in size as well as floc fiber which is precision-cut short fibers cut to <6 mm in size. The preferred fiber of the present invention is pulp form fiber because the fibrillation process results in various fiber lengths and shapes that better lends to random orientation while floc fiber is precision-cut and more uniform. The aforementioned terms are commonly known when referring to DuPont's KEVLAR® (aramid fiber), however these terms “floc fiber and “pulp fiber” along with their aforementioned definitions and the further definition below are be to known as the same definition for all types of fiber mentioned throughout this patent.

Floc fibers are precision-cut short fibers which typically range from approximately 1/25 to ¼ inch in length. Floc is commonly used in a wide variety of reinforcement resin systems. Pulp, a highly fibrillated form of fiber is commonly used in brakes and gaskets as a replacement for asbestos and in specialty composites. Reference: Aramid Fiber Formed of Poly-Phenylene Terephthalamide from the Netherlands: An International Trade Investigation (by DIANE Publishing Company).

Pulp fibers or fibrillated fibers are known as processed fibers that are split up into fibrils resulting in a high surface area. The aforementioned Fibrillated fibers are ideal for dispersion into a liquid for the purpose of uniform viscosity. Fibrillated fiber is the general term for processed fibers that are refined to develop fibers with a higher surface area and branched structure. Fibrillated fibers are commonly used for papermaking. [8] [9]

Fibers in pulp or floc form could be made from para-aramid fiber such as KEVLAR®, TWARON®, etc (poly-paraphenylene terephthalamide) as well as other synthetic fibers and natural fibers made from wood or other cellulose based fiber.

The preferred embodiment of the present invention includes the use of pulp fiber in any form such as dry and/or pre-dispersed into any form or compound of liquid. Certain types of pulp fiber are available in both aforementioned forms and the preferred embodiment of the present invention is the use of KEVLAR® pulp fiber in dry form which requires the fiber to be emulsified into the sealant compound for uniform distribution into the compound.

The use of the term “liquid latex” shall be defined and known as the following below description through the entirety of this patent. Liquid latex is available in natural and synthetic forms. The present invention proposes the use of any form of liquid latex. Liquid latex is commonly preserved with ammonia and available in different concentrations as well as processed in a variety of different ways. The preferred embodiment of the present invention is a Low Ammonia Centrifuged Natural Latex, but the present invention is not limited to the use of this specific liquid latex and is considered one of the many possible embodiments of the present invention.

The use of the term “strand fiber” or “staple fiber” shall be defined and known as the following below description through the entirety of this patent. Staple or strand fiber consists of precision-cut short fibers, ¼inch or longer in length. [10] [11] [12]

### SUMMARY OF THE INVENTION

The present invention proposes the in tandem use of floc/pulp fiber with liquid latex. The use of the aforementioned ingredients within a tire sealant formulation are needed to provide a 4 key characteristics: permanent seal and/or repair of a leak and/or puncture, low viscosity in order to achieve low flow resistance and a clump free formulation which requires less quantity of tire sealant to fully coat and protect and/or seal the tire from leaks and/or punctures, and lastly to provide a tire sealant that is water soluble and easy to clean up or remove from the inside of a tire with a low pressure garden hose. The aforementioned characteristics of the present invention are described in detail in this patent.

### DESCRIPTION OF RELATED ARTS

The concepts and formulations of tire sealant for the purpose of stopping the loss of air from punctures and/or leaks in pneumatic tires are well known and abundant. Even with these well-known concepts and abundances of proposed inventions and solutions from prior art, many of the said prior art compositions suffer from a variety of disadvantages. One of the key disadvantages of prior art tire sealant formulations is the lack of a permanent seal that will provide a seal and/or repair of the leak and/or puncture that lasts the life of the tire. It is common for a tire with prior art tire sealant formations to lose air pressure after the tire suffers a leak and/or puncture and this is due to the lack of adhesive ingredients, for example the use of liquid latex which is proposed in the present invention. Another disadvantage of prior art tire sealant formulations is a tire sealant composition that is of high viscosity. The use of longer stranded or staple form fiber >2 mm can have a tendency to clump and ball up forming a thicker, chunkier tire sealant formation that does not flow quickly and due to the thicker, higher viscosity of prior art tire sealants which require a large amount of tire sealant to evenly coat the inside of the tire in order to provide adequate leak and/or puncture protection. Another disadvantage of prior art tire sealant formulations in relation to the aforementioned thick viscosity and sticky/gooey characteristics is the mess created while removing the tire sealant liquid while dismounting the tire for a permanent repair (A permanent repair is not commonly achieved by prior art formulations) or dismounting the tire for replacement at the end of the tires life due to tread wear, dry rot, etc. . . . . Prior art tire sealants are messy and difficult to remove from the inside the tire and commonly destroy the tire. Prior art tire sealants are also formulated to stay liquid for the life of the tire and are known to deteriorate the tires rubber causing premature tire failure and can also deteriorate the rim causing the rim to rot, rust and/or corrode. The present invention does not suffer from the aforementioned disadvantages because the present invention proposes the use of liquid latex as one of the base ingredients which will coagulate over time into a rubber material. With regular rotation over a 6-18 month time period the liquid latex will slowly collect and coagulate around the inside of the tire and fully dry out for virtually no hassle while removing the tire. After the 6-18 month time period it is recommended that the user re-apply additional tire sealant for continued flat protection or simply re-apply additional tire sealant if/when the user suffers another leak and/or puncture.

Therefore, a tire sealant is needed that provides a means of adhering the leaks and/or punctures for a permanent seal as well as a tire sealant that will offer low flowing resistance through a low viscosity liquid that is smooth and free of clumps and/or chucks. These characteristics offer easier cleanup and a permanent seal is achieved with the use of a liquid latex and fiber pulp/floc. The present inventions proposes the use of the aforementioned ingredients to be used in tandem within a tire sealant formulation for the purpose of providing the solution to the aforementioned disadvantages.

Furthermore, prior art tire sealant formulations commonly relate the particles as a range of percentage by weight of the entire composition. Due to the different weights and sizes of fibers the present invention does not explicitly state the range of particles (in the case of this patent, floc and/or pulp fiber). The present invention is proposing the use of floc and/or pulp fiber in any form, size, or ratio used in tandem with a liquid latex within a tire sealant formulation which optionally can contain other types of particles or liquids. The preferred embodiment of fiber is DuPont KEVLAR® aramid fibers which are among the lightest fibers known and can take on a drastically different ratio in comparison to fibers of a different type and size.

### OBJECTS OF THE INVENTION

It is an object of the present invention to provide a tire sealant formula that can be used to repair or prevent a tire from loss of air due to punctures and/or leaks in any area of the tire or the seal between tire and rim called the bead.

It is another object of the present invention to provide a tire sealant formula with the use of natural or synthetic pulp fiber (or a combination of both). The preferred embodiment of the present invention is the use of Aramid fiber (commonly referred to as KEVLAR®) in pulp form. KEVLAR® Pulp fiber is milled down to 0.5-1 mm in size which specifically lends the pulp fiber to maintaining a low viscosity tire sealant for low flowing resistance while coating the inside of the tire. The low viscosity and low flowing resistance formulation is key to providing a tire sealant that can allow for up to 80% less being applied for tire repair or prevention of flat tires. A thicker, higher viscosity product requires more liquid in order to fully coat and protect a tire. The present invention proposes a sealant formulation that is up to 80% thinner in viscosity than prior art tire sealant formulations which allows for less product to sufficiently coat the inside of the tire and provide superior puncture and leak protection with permanent repair with the use of liquid latex. The thinner formulation of the present invention also allows the tire sealant to reach the bead area of the tire because the thin, low viscosity formulation can easily slosh and move to all areas of the tire while thicker, high viscosity tire sealants are forced to the tread area and stay at the center tread area due to centrifugal force.

It is another object of the present invention to provide a tire sealant formulation that will permanently seal and adhere the pulp fiber particles into the puncture and/or leak. The present invention relates to the use of liquid latex as the adhesive agent that will provide the permanent seal. The use of liquid latex is the key to creating a low viscosity tire sealant formulation that still provides the permanent repair and/or prevention of leaks and/or punctures that cause air loss in a pneumatic tire leading to flat tires. The preferred embodiment defines low viscosity as a liquid between 1 and 60 Centistokes. For example if one were to substitute the liquid latex for a low viscosity liquid containing no adhesive characteristics such as water and continue to use a particle such as KEVLAR® fiber pulp the water and fiber pulp formulation will not achieve a permanent seal even though you would achieve a low viscosity formulation offering the same low flow resistance. The liquid latex is the key to formulating a thin viscosity tire sealant that offers a permanent seal of any leaks and/or punctures and the fiber pulp is the key to maintaining a low flowing resistance tire sealant that is smooth flowing, free of clumps and stays evenly suspended into the liquid during movement without floating or sinking.

It is a further object of the invention to create a natural, environmentally friendly tire sealant that is water soluble and provides a permanent seal regardless of puncture and/or leak in any part of the tire and/or the seal between tire and rim, commonly referred to as the bead. The light weight, low viscosity, water soluble nature of the present invention allows for easy cleanup of spills or clean up off the inside of the tire with a low pressure garden hose. Competing high viscosity tire sealants are difficult to clean up from spills or from the inside of a tire which is important during tire replacement at the end of the tires life. The use of liquid latex in the present invention allows for a tire sealant that will fully dry out over 6-18 month time period leaving zero clean up at the end of tire life. If the tire is replaced before that time period; clean up during tire replacement is simplified due to the low viscosity and water soluble nature of a base formulation comprising of liquid latex. The liquid latex allows for the sealing properties to be provided even with a low viscosity formulation and lends to the easy clean up both in liquid state and when the liquid latex formulation is fully coagulated and dried out in the tire.

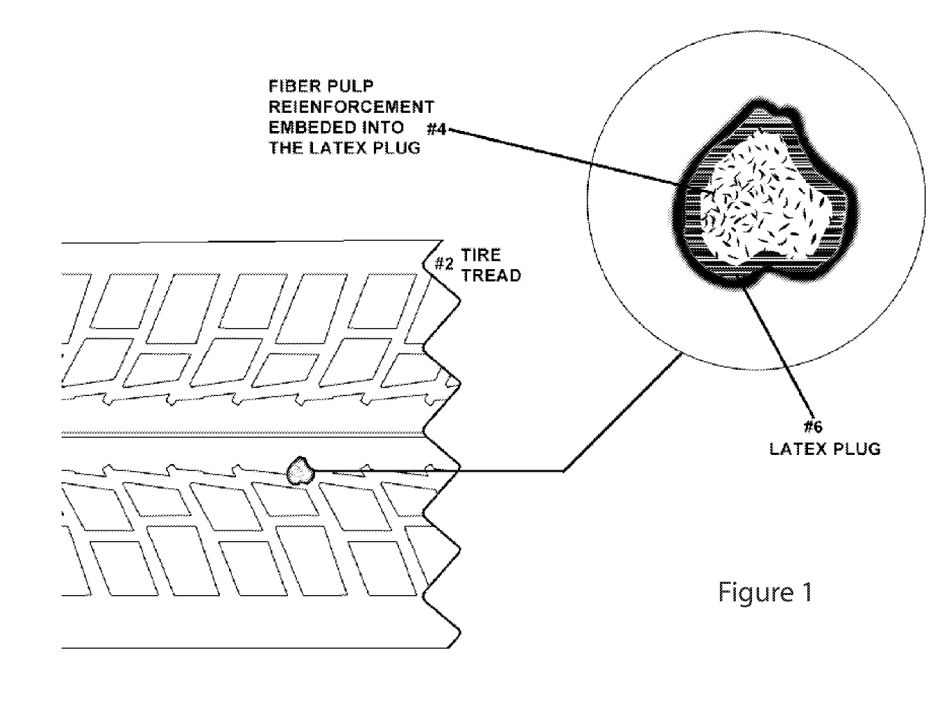

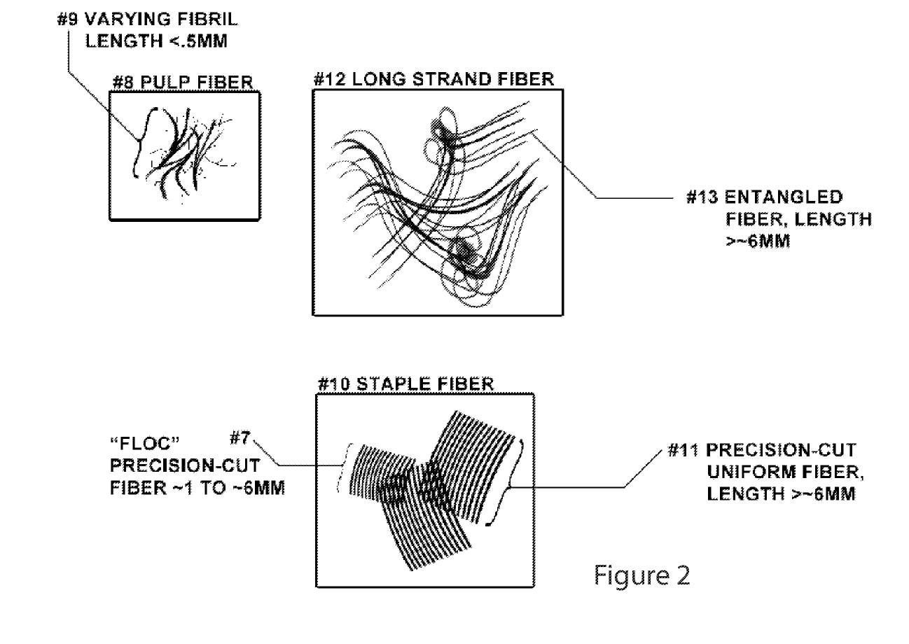

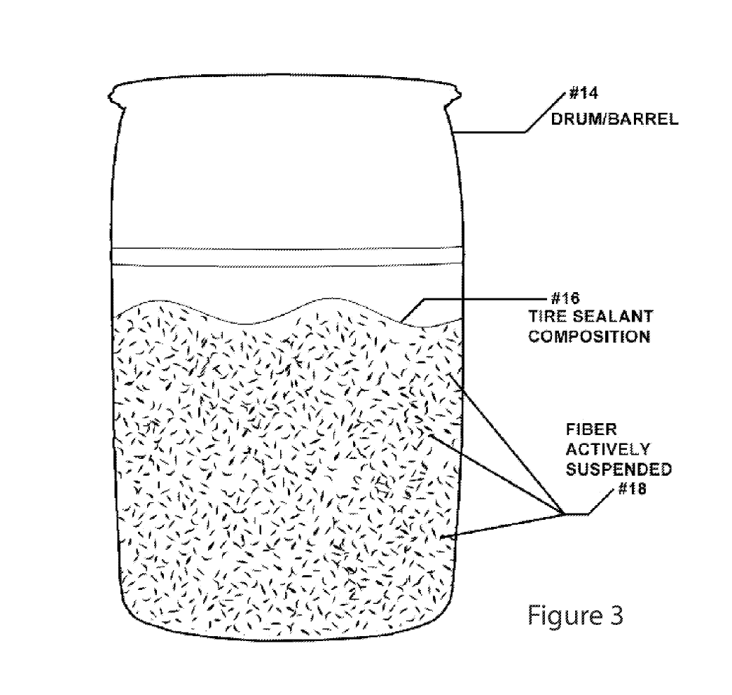

### DESCRIPTION OF THE DRAWINGS

[2][4][6] FIG. 1 shows a Latex/Fiber plug adhered into a puncture in the thread area.

[8][10][12] FIG. 2 shows a Pulp fiber in comparison to precision cut staple fiber and strand fiber.

[14][16][18] FIG. 3 shows a Barrel of tire sealant in liquid form showing the dispersion of fiber within the compound.

### DETAILED DESCRIPTION

How does tire sealant work: The premise of prior art tire sealants is the concept of creating a liquid that will permanently suspend particles/objects throughout the mixture which is commonly achieved by creating a thicker viscosity liquid that will allow for the suspension of particles/objects as well as evenly coating and sticking to the tread area of the tire. Prior art tire sealants are designed to stay in the tread area by formulating a thick, gooey and sticky tire sealant. Many prior art tire sealants do not contain adhesive properties and relies on stopping the leak and/or hole and/or puncture by forcing particles/objects into the leak and this is the same reason why prior art tire sealants do not provide a permanent seal. The present invention takes a different approach and is only achievable with the use of liquid latex and pulp fiber. The present invention proposes the creation of a low viscosity, lightweight, fast flowing, and low flowing resistance liquid that is not designed to permanently suspend particles and the present invention is also not designed to stay in the tread area. The present invention proposes the use of liquid latex and pulp fiber for a variety of purposes and reasons. The use of liquid latex and pulp fiber lends to creating a thin viscosity tire sealant that is fast flowing and actively coats the tire by creating a small puddle of sealant that is even disbursed through centrifugal force during tire rotation. The centrifugal forces exerted on the tire while rolling the tire is sufficient to evenly coat the entire tire during rotation and when rotation stops, removing the centrifugal forces, the tire sealant will quickly recollect and puddle at the bottom of the tire in the matter of seconds. Furthermore the use of liquid latex as the base creates a tire sealant that has permanent sealing properties that will adhere the fiber pulp into a clot/plug. An additional purpose of formulating with liquid latex as the adhesive agent are the flexibility characteristics when the liquid latex dries into a rubber like material it will flex and distort to maintain the permanent seal even with the stresses endured by tires during braking, turning, etc. regardless of the puncture/leak location (tread, sidewall, bead). The present invention also notes that creating a tire sealant with permanently suspended particles/objects throughout the mixture is not an important characteristic and not an object of the present invention. Instead the present invention proposes a sealant that is of low viscosity and will actively and evenly suspend the particles during rotation and movement of the tire due to centrifugal force. Even though the pulp fiber particles in the proposed tire sealant will partially sink/settle to the bottom and partially float to the top, the creation of a thin viscosity, smooth, fast flowing tire sealant with the use of liquid latex and pulp fiber allows the tiny pulp form fibers to actively and evenly suspend throughout the liquid on demand during rotation of the tire. While in comparison to prior art tire sealant formulations that are of high viscosity, it requires particles to be permanently suspended to maintain an even distribution of particles in the thicker formation which does not actively flow and mix particles during rotation. Permanently suspending particles is not an object of the present invention and not required in the present invention of formulating a tire sealant with liquid latex used in tandem with pulp fiber for all of the prior mentioned purposes and advantages already stated in this patent.

The use of liquid latex also lends to sealing smaller punctures, holes and/or leaks including bead leaks that are too small for particles to plug. Tire punctures caused by foreign objects are often ⅛-¼inch in diameter which require particles to form a clot or plug in the puncture and/or leak. Smaller leaks common at the bead or during the manufacturing process which are less than 0.5 mm are too small for even a single particle to clot, plug or wedge into the puncture and/or leak. The use of liquid latex in the tire sealant formulation will seal micro holes that are <0.5 mm. The liquid latex when formulated with a particular preservative destabilizes the compound and causes rapid coagulation of the latex compound when exerted to the shock of a pressure differential created while air pressure is rapidly escaping a leak or puncture. The present invention comprising of a liquid latex compound will coagulate on contact of the aforementioned air pressure differential. The aforementioned characteristic of the liquid latex compound are the characteristics which will seal smaller holes and/or leaks and the same characteristics that work to form a clot and/or plug on larger leaks and/or punctures when particle additives including any natural or synthetic fiber pulp. The aforementioned fiber pulp offers properties superior to other particles and even larger staple or stranded fiber. Fiber in staple or strand form will clump and entangle in a liquid which creates a lumpy, high viscosity liquid that is not desirable for creating a smoother faster flowing, low viscosity tire sealant. The use of fiber pulp lends to creating a thinner (low viscosity) tire sealant that requires less quantity of tire sealant to achieve sufficient coating around the tire as well as provide a repair of a flat tire or to provide prevention of future flat tires caused by punctures and/or leaks. In order to formulate a thin viscosity tire sealant that provides the aforementioned sealing properties it is key to use the formulation characteristics of the present invention which include the use of a natural or synthetic liquid latex to provide the adhesion needed to form a clot and/or plug while the use of natural or synthetic fiber pulp provides a filler agent to seal larger holes, punctures, leaks without affecting the flowing properties and maintaining a low viscosity, fast flowing, low flowing resistance liquid tire sealant.

The use of liquid latex and pulp fiber also requires specific means of dispersion into the formulation in order to evenly and actively disperse the pulp fiber into the formulation. For example, one cannot simply add dry pulp fiber into a liquid without processing to enable even dispersion. Adding dry pulp fiber will result in a formulation that is clumpy and not favorable for use as a tire sealant. The preferred embodiment of the present invention is proposing the use of pulp fiber within a tire sealant composition that is emulsified in order to achieve smooth and even distribution of the fiber within the composition.

The preferred embodiment of the present invention details the use of Aramid fiber pulp such as KEVLAR® Fiber pulp formulated with liquid latex as previously mentioned. The use of Aramid/KEVLAR® fiber is preferred over other types of fibers because of following characteristics. Aramid/KEVLAR® fiber is synthetic and does not weaken or otherwise deteriorate its structure and strength as much as natural fibers while saturated in a liquid. Aramid/KEVLAR® fiber in the pulp form is milled to 0.5-1 mm in size making it an ideal fiber for use in tire sealant for application through a valve stem as well as maintaining the low viscosity, smooth (non-chunky/clumpy), fast flowing, low flowing resistance properties as previously mentioned in this patent. Aramid/KEVLAR® fiber is also readily available on the market in pulp form where most synthetic fibers are not available in pulp form. Natural cellulose fibers are commonly found in pulp form but are not the desired embodiment for use in a tire sealant mixture because they will breakdown and lose structure when saturated by a liquid, unlike Aramid/KEVLAR®. Aramid/KEVLAR® is also a stronger fiber that has excellent heat resistance and tensile strength to stand up to the abuse tires are subjected to on road and off road terrain. The preferred embodiment of the present invention enables a tire sealant composition that will form a latex/KEVLAR® plug that will wedge into any leaks or punctures in the tire causing air loss. When the aforementioned tire sealant contacts a leak or puncture in the tire, the latex will coagulate inside of the leak or puncture and form a rubber like plug reinforced by KEVLAR® that is adhered in place. The use of Aramid/KEVLAR® fiber as the reinforcement is ideal because of its strength, heat resistance and flexibility. The latex and Aramid/KEVLAR® plug can flex and move with the rubber tire as it endures flexing, deformation and the like as the tire traverses different terrains and undergoes stress from acceleration, braking and turning. [6]

To make shorter pulp or floc fibers an effective reinforcement it is important to have an even dispersion in the tire sealant formulation. In order to achieve uniform dispersion of such a small (0.5 mm-1 mm) and lightweight fiber it is favorable to formulate with a low viscosity liquid in order to keep the pulp fibers actively and randomly dispersing within the tire sealant formulation during tire movement and rotation. In thicker, higher viscosity prior art formulations pulp fiber will not disperse and randomly orient at anywhere near the same rate. An example to illustrate the aforementioned characteristics. If pulp fiber were dispersed into a thicker viscosity liquid similar to olive oil or motor oil the pulp fiber will move very slowly when the pulp fiber and liquid mixture is agitated. In comparison a low viscosity liquid like water will very actively orient and move the pulp fiber in many different positions and forms creating a far more dynamic network of randomly oriented and shaped pulp fiber for the purpose of forming a clot or plug into a puncture/hole/leak in a pneumatic tire that is losing air pressure.

Pulp fiber is desirable over other particles because pulp fiber will create a fiber network mesh as the fibers will randomly interlink and connect which allows for more substantial, stronger plugs to be formed inside the puncture of the tire. The in tandem use of liquid latex lends to building up a pulp fiber network on the inside of the tire. The pulp fiber is lightly adhered to the inside surface of the tire and with randomly mix and orient as the tire rotates. Over time, for example 6-18 months the liquid latex will coagulate and the formulation will dry to adhere the fiber network evenly around the inside surface of the tire. The aforementioned characteristics are favorable to make a tire sealant that is easy to clean up from the inside of the tire. A lightweight/thin/low viscosity formulation with the aforementioned liquid latex as one of the base ingredients with typically be fully coagulated/dried out/setup into a rubber like material (depending on the other ingredients in the formulation on top of liquid latex) making for a zero mess and no clean up while de-mounting and replacing a tire. If the aforementioned tire sealant formulation characteristics are still liquid during tire replacement or de-mounting it can be easily removed because liquid latex lends itself to being water soluble and eco-friendly as well as non-sticky/goopy allowing it to easily rinse away with a low pressure garden hose or wet cloth.

The tire sealant mixture contains latex and could also contain a preservative and/or antifreeze for the purpose of extending the length of time the mixture stays liquid as well as providing anti-freeze properties. An example of this is propylene glycol. The mixture could also contain any form of water (mineralized (aka tap), deionized, distilled, etc. . . . ). And the mixture could also contain additional fillers, stranded fibers, and/or particles to compliment the pulp fiber.

While a pneumatic tire suffers from air loss caused by a leak or puncture a tire sealant compound as described by the preferred embodiment will quickly reach the leak when the tire is rotating. The low viscosity liquid easily coats the tire and flows to the leak or puncture while the tire is rotating. After rotation has stopped the preferred embodiment tire sealant will quickly re-pool and puddle to the bottom of the tire. When the preferred embodiment tire sealant contacts the leak or puncture the liquid latex formulation will clot and form a plug reinforced by pulp fiber. The pulp fiber also acts as a filler to seal larger diameter leaks or punctures, without the fiber the size of leak or puncture the compound is able to seal is greatly limited. After the latex/fiber plug initially stops the leak, the latex will fully coagulate and dry into a plug that is adhered into place inside the leak or puncture. The aforementioned characteristics give the preferred embodiment tire sealant a permanent seal that will in most cases last the life of the tire.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

I claim:

1. A tire sealant composition where:
a. liquid is between 1 and 60 Centistokes;
b. composition is used for sealing punctures, holes, leaks in any type of a pneumatic tire.

2. The tire sealant composition according to claim 1, wherein the types of fiber particles are pulp or floc in dry or wet forms.

3. The tire sealant composition according to claim 1, wherein the composition is used with liquid latex.

4. The tire sealant composition according to claim 3, wherein the Liquid latex is any form natural or synthetic.

5. The tire sealant composition according to claim 3, wherein Liquid latex is a sealant composition that contains any other liquid ingredients acting as an anti-corrosive agent, preservative, or anti-freeze agent.

6. The tire sealant composition according to claim 1, wherein the Particles include the use of complementary particles synthetic or natural. Granulated/Milled/Powdered rubber or other synthetic particle in the size range of 0.2 mm-2 mm. Granulated/Milled/Powdered cellulose or other natural particle in the size range of 0.2 mm-2 mm.
